(19) United States
(12) Patent Application Publication
(10) Pub. No.: US 2025/0144519 A1
(43) Pub. Date: May 8, 2025

(54) INFORMATION DISPLAY METHOD AND APPARATUS

(71) Applicant: Tencent Technology (Shenzhen) Company Limited, Shenzhen (CN)

(72) Inventor: Yanan ZHANG, Shenzhen (CN)

(73) Assignee: Tencent Technology (Shenzhen) Company Limited, Shenzhen, GD (CN)

(21) Appl. No.: 19/008,467

(22) Filed: Jan. 2, 2025

Related U.S. Application Data
(63) Continuation of application No. PCT/CN2023/123239, filed on Oct. 7, 2023.

(30) Foreign Application Priority Data
Nov. 15, 2022 (CN) 202211430221.3

(51) Int. Cl. A63F 13/52; A63F 13/79; A63F 13/822

(52) U.S. Cl. CPC A63F 13/52; A63F 13/79; A63F 13/822; A63F 2300/308; A63F 2300/558; A63F 2300/807

(57) ABSTRACT

An information display method is provided. In the method, a first virtual object of a plurality of virtual objects in a first level of a chess game is displayed. The first virtual object is associated with a first user account. When a number of the plurality of virtual objects of the first level reaches a preset number, a first voucher and a second virtual object of a second level are displayed. The second virtual object is synthesized based on the preset number of the plurality of virtual objects. At least two candidate virtual objects are displayed when the first voucher is redeemed. When one of the at least two candidate virtual objects is selected by the first user, the selected candidate virtual object is displayed. The selected candidate virtual object is obtained by the first user account.

### RELATED APPLICATIONS

The present application is a continuation of International Application No. PCT/CN2023/123239, filed on Oct. 7, 2023, which claims priority to Chinese Patent Application No. 202211430221.3, filed on Nov. 15, 2022. The entire disclosures of the prior applications are hereby incorporated by reference.

### FIELD OF THE TECHNOLOGY

Embodiments of this application relate to the field of application development technologies, including to an information display method and apparatus, a terminal device, a storage medium, and a program product.

### BACKGROUND OF THE DISCLOSURE

In an auto chess game, the concept of upgrading a virtual object is involved, such as upgrading from a lower level to a higher level.

In the related art, virtual objects of a first level can be obtained by defeating monsters and enemies, and a virtual object of a second level is obtained by synthesizing the virtual objects of the first level, to enhance battle power of a user in the auto chess game.

In the foregoing related art, it is difficult and time-consuming to obtain the virtual objects of the first level and synthesize the virtual objects of the first level to obtain the virtual object of the second level, resulting in low efficiency in enhancing the battle power of a user account in the auto chess game.

### SUMMARY

Embodiments of this disclosure provide an information display method and apparatus, a terminal device, a storage medium, and a program product, which can improve efficiency of enhancing the battle power of a user account in an auto chess game. The technical solutions are as follows:

According to an aspect of the embodiments of this disclosure, an information display method is provided. In the method, a first virtual object of a plurality of virtual objects in a first level of a chess game is displayed. The first virtual object is associated with a first user account. When a number of the plurality of virtual objects of the first level reaches a preset number, a first voucher and a second virtual object of a second level are displayed. The second virtual object is synthesized based on the preset number of the plurality of virtual objects. At least two candidate virtual objects are displayed when the first voucher is redeemed. When one of the at least two candidate virtual objects is selected by the first user, the selected candidate virtual object is displayed. The selected candidate virtual object is obtained by the first user account.

According to an aspect of the embodiments of this disclosure, an information display apparatus is provided. The apparatus includes processing circuitry that is configured to display a first virtual object of a plurality of virtual objects in a first level of a chess game. The first virtual object is associated with a first user account. The processing circuitry is configured to display a first voucher and a second virtual object of a second level when a number of the plurality of virtual objects of the first level reaches a preset number. The second virtual object is synthesized based on the preset number of the plurality of virtual objects. The processing circuitry is configured to display at least two candidate virtual objects when the first voucher is redeemed. The processing circuitry is configured to display the selected candidate virtual object as obtained by the first user account when one of the at least two candidate virtual objects is selected by the first user.

According to an aspect of the embodiments of this disclosure, a terminal device is provided. The terminal device includes a processor and a memory, the memory having a computer program stored therein, the computer program being loaded and executed by the processor to implement the foregoing information display method.

According to an aspect of the embodiments of this disclosure, a non-transitory computer-readable storage medium is provided. The non-transitory computer-readable storage medium has a computer program stored therein, the computer program being loaded and executed by a processor to implement the foregoing information display method.

According to an aspect of the embodiments of this disclosure, a computer program product is provided. The computer program product includes a computer program, the computer program being stored in a computer-readable storage medium. A processor of a computer device reads the computer program from the computer-readable storage medium and executes the computer program, to cause the computer device to perform the foregoing information display method.

The technical solutions provided in the embodiments of this disclosure may include the following beneficial effects:

When a virtual object of a higher level is obtained by synthesizing n virtual objects of the same type and the same level, an additionally obtained voucher is displayed. When completing synthesis and upgrade of the virtual objects, a user account can obtain not only a virtual object whose level has been increased by synthesizing the virtual objects, but also another virtual object by using the additionally obtained voucher. By redeeming the voucher for the virtual object, it is helpful to continue to help the user account upgrade the obtained virtual object, improve the speed of upgrading the virtual object in the auto chess game, and quickly enhance the overall battle power of the user account, that is, improve the efficiency of enhancing the battle power of the user account in the auto chess game.

In addition, it is helpful to accelerate the pace of the game, shorten the duration of the game battle, and reduce power consumption of running the terminal device. Moreover, increasing a quantity of user accounts waiting to be matched at the same time helps reduce the calculation pressure on the server in matching the user accounts to an appropriate game battle.

### BRIEF DESCRIPTION OF THE DRAWINGS

FIG. 1 is a schematic diagram of an implementation environment according to an embodiment of this disclosure.

FIG. 2 is a flowchart of an information display method according to an embodiment of this disclosure.

FIG. 3 is a schematic diagram of a user interface according to an embodiment of this disclosure.

FIG. 4 is a schematic diagram of a user interface according to another embodiment of this disclosure.

FIG. 5 is a schematic diagram of a user interface according to another embodiment of this disclosure.

FIG. 6 is a schematic diagram of a user interface according to another embodiment of this disclosure.

FIG. 7 is a schematic diagram of a virtual object according to an embodiment of this disclosure.

FIG. 8 is a schematic diagram of a user interface according to another embodiment of this disclosure.

FIG. 9 is a flowchart of an information display method according to another embodiment of this disclosure.

FIG. 10 is a flowchart of an information display method according to another embodiment of this disclosure.

FIG. 11 is a block diagram of an information display apparatus according to an embodiment of this disclosure.

FIG. 12 is a block diagram of an information display apparatus according to another embodiment of this disclosure.

FIG. 13 is a block diagram of a terminal device according to an embodiment of this disclosure.

### DESCRIPTION OF EMBODIMENTS

Aspects of the present disclosure are described below in further detail and shown in the accompanying drawings. When the following descriptions are made with reference to the accompanying drawings, unless otherwise indicated, the same numbers in different accompanying drawings represent the same or similar elements.

Descriptions of terms in this disclosure are provided as examples only and are not intended to limit the scope of the disclosure.

First, an auto chess game involved in the embodiments of this disclosure is briefly introduced.

The auto chess game is a game competition in which a plurality of user accounts participate by setting up a chess game to battle. A quantity of user accounts participating in a chess game may be 2, 4, 6, 8, 20, 40, 80, 100, or the like. In some embodiments, the quantity of user accounts participating in a chess game may be specifically set by relevant technical personnel according to an actual situation. This is not specifically limited in the embodiments of this disclosure.

In some embodiments, a user interface of the auto chess game displays a chess game set up by a user account. In some embodiments, the user interface displays a chess board, and the chess board may include a battle area and a preparation area. The battle area includes several battle squares of the same size. The battle squares are configured for placing virtual objects (that is, battle pieces) for a battle in a battle process. The preparation area includes several preparation squares. The preparation squares are configured for placing virtual objects preparation. The virtual objects for preparation does not participate in the battle in the battle process, but may be dragged and placed in the battle area in a preparation stage. In some embodiments, the virtual objects for a battle (that is, the battle pieces) and the virtual objects for preparation are collectively referred to as virtual objects. An image of the virtual object includes, but is not limited to: a virtual character, a virtual animal, an animated character, and the like. In some embodiments, the virtual object is displayed by using a three-dimensional model. A virtual object display method is not limited in this disclosure.

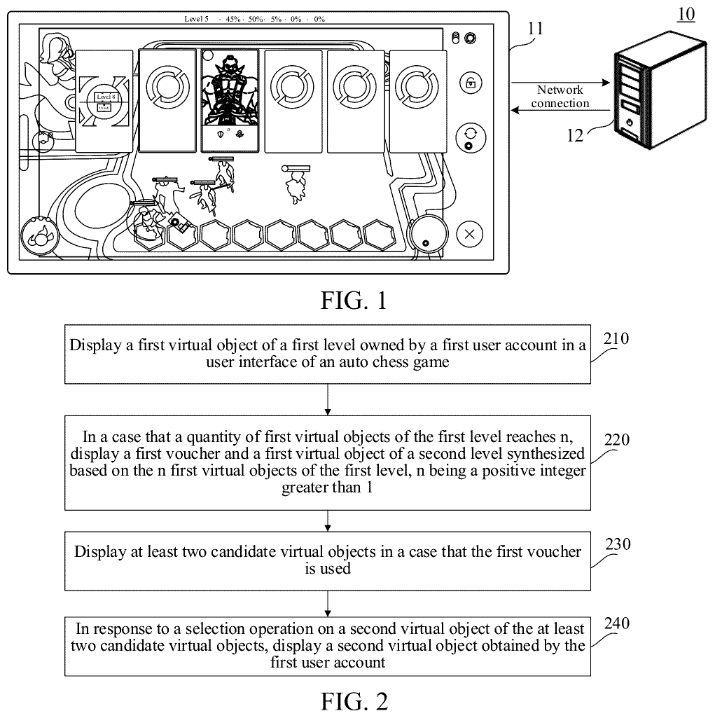

FIG. 1 is a schematic diagram of an implementation environment according to an embodiment of this disclosure. The implementation environment may be implemented as an information display system. As shown in FIG. 1, the system 10 may include: a terminal device 11.

A target application, such as a client of the target application, is installed and run in the terminal device 11. In some embodiments, a first user account is logged in to the client. The terminal device 11 is an electronic device having data calculation, processing, and storage capabilities. The terminal device may be a smartphone, a tablet computer, a personal computer (PC), a wearable device, or the like. This is not limited in the embodiments of this disclosure. The target application may be a game application, for example, an auto chess game application. The target application may further be any application having an information display function, such as a social application, a payment application, a video application, a music application, a shopping application, or a news application. In the method provided in the embodiments of this disclosure, each operation may be performed by the terminal device 11, for example, the client running in the terminal device 11.

In some embodiments, the system 10 further includes a server 12. The server 12 establishes a communication connection (such as a network connection) with the terminal device 11. The server 12 is configured to provide a backend service for the target application. The server may be an independent physical server, or may be a server cluster including a plurality of physical servers or a distributed system, or may be a cloud server that provides cloud computing services.

The technical solutions of this disclosure are described below by using several embodiments.

FIG. 2 is a flowchart of an information display method according to an embodiment of this disclosure. The method may be performed by a terminal device. In this embodiment, an example in which the method is applied to the client of the terminal device above is used for description. The method may include at least one of the following operations (210 to 240).

Operation 210: Display a first virtual object of a first level owned by a first user account in a user interface of an auto chess game.

In some embodiments, the user interface of the auto chess game includes a game chess board. In some embodiments, the game chess board is an area in the user interface of the auto chess game for preparing for and participating in a battle. The game chess board is configured for displaying virtual objects in the battle of the auto chess game. In some embodiments, the virtual object is a smallest battle unit used by a virtual object lineup matched by a first user object in a game battle.

In some embodiments, the first virtual object is a virtual object obtained by the first user account in the game battle. In some embodiments, the first virtual object is a virtual object that has been used by the first user account in the game battle. For example, the first virtual object is any virtual object belonging to the first user account in the game chess board. In some embodiments, different types of virtual objects are provided in the auto chess game. Different virtual objects have different game attributes, and a player arranges the virtual objects in the game chess board according to an actual situation. In some embodiments, the first user account participates in the auto chess game based on the owned virtual objects, and battles with virtual objects of other user accounts, thereby battling and competing with the other user accounts in the auto chess game. The user account may be controlled by a corresponding user, or may be automatically controlled by artificial intelligence (AI). This is not specifically limited in the embodiments of this disclosure.

In some embodiments, virtual objects of the same type in the auto chess game have a plurality of levels, for example, a first level, a second level, and a third level. In some embodiments, for game objects of the same type, different levels correspond to different game attributes. A quantity of levels corresponding to each virtual object may be set by relevant technical personnel according to an actual situation, for example, may be two, three, or four. This is not specifically limited in the embodiments of this disclosure.

In some embodiments, a plurality of first virtual objects can be synthesized to obtain a new first virtual object. In some embodiments, n first virtual objects of the first level are configured for synthesizing a first virtual object of a second level, and n is a positive integer greater than 1. For example, n may be a value such as 2, 3, 4, 5, or the like. This is not specifically limited in the embodiments of this disclosure.

In some embodiments, a specified quantity (for example, n) of virtual objects of the same type of a lower level can trigger synthesis of a virtual object of a higher level, that is, a plurality of virtual objects of a lower level are synthesized to obtain a corresponding virtual object of the same type of a higher level, to upgrade the virtual object. For example, three first virtual objects of the first level may be synthesized to obtain a first virtual object of the second level. The first level is lower than the second level. In another example, three first virtual objects of the second level may be synthesized to obtain a first virtual object of the third level. The second level is lower than the third level. In some embodiments, in the auto chess game, battle power of the first virtual object of the second level is superior to battle power of the first virtual object of the first level; and in the auto chess game, battle power of the first virtual object of the third level is superior to the battle power of the first virtual object of the second level. The battle power includes, but is not limited to, at least one of the following: a health point, an attack value, a magic value, and a movement speed of the virtual object.

The first virtual object of the first level is obtained in the following several manners.

Manner 1: Redeem a virtual resource for the first virtual object of the first level.

In some embodiments, in a resource redemption interface, the first user account redeems the virtual resource for the first virtual object. The resource redemption interface displays at least one virtual object for which the virtual resource can be redeemed. In some embodiments, the at least one virtual object includes the first virtual object. For example, in response to an operation of selecting the first virtual object in the resource redemption interface, the terminal device deduces virtual resources of a first quantity, and displays, in the user interface, that a quantity of first virtual objects owned by the first user account increases by m, m being a positive integer. For example, m=1.

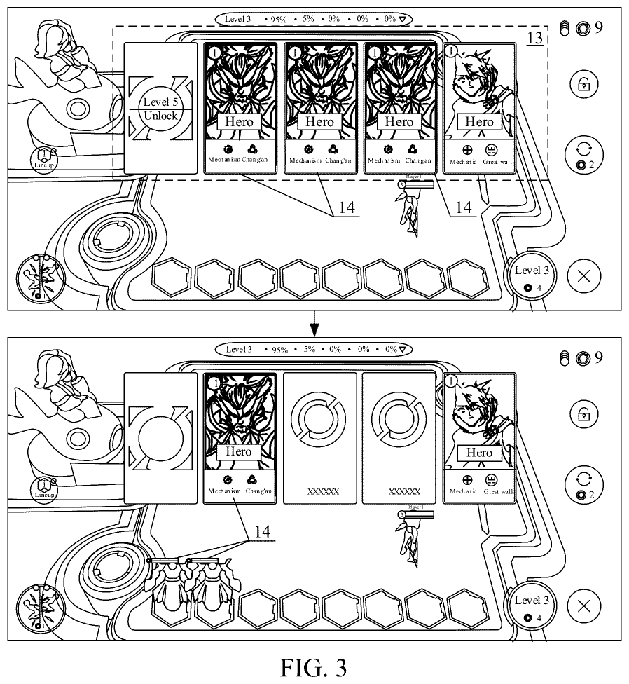

As shown in FIG. 3, the terminal device displays a resource redemption interface 13 in the auto chess game (for example, an interface of a virtual store in the auto chess game). The resource redemption interface 13 displays one or more virtual objects that can be obtained by redeeming the virtual resource, for example, the first virtual object of the first level. In some embodiments, the virtual resource may be a virtual game currency. The virtual game currency may be obtained by recharging with real money or by completing tasks. This is not specifically limited in the embodiments of this disclosure.

Manner 2: Obtain the first virtual object of the first level by using a skill.

In some embodiments, the first user account corresponds to some skills, and the skills are configured for enhancing the overall battle power of the first user account in the auto chess game. In some embodiments, the skill corresponding to the first user account is a skill of a virtual character played by the first user account in the game battle, or a skill corresponding to a skill prop carried by the first user account when entering the game battle, or a skill of a virtual object owned by the first user account. A skill effect of the skill corresponding to the first user account includes, but is not limited to, at least one of the following: adding a virtual object to the game chess board, or enhancing the battle power of the virtual object owned by the first user account. By using the skills corresponding to the first user account, the overall lineup of the virtual objects can be strengthened, and the competitiveness of the virtual objects in the battle can be enhanced.

In some embodiments, there is a use limitation on the skills corresponding to the first user account. The use limitation includes, but is not limited to, at least one of the following: number of uses, frequency of use, timing of use, or the like. In some embodiments, in response to an operation of casting a first skill, the terminal device verifies whether there is a use limitation on the first skill; and if there is no use limitation on the casting of the first skill, the terminal device casts the first skill, and displays an effective effect of the first skill. The first skill is any skill owned by the first user account. For example, the first skill is configured for increasing the quantity of virtual objects owned by the first user account, that is, assisting the first user account in obtaining at least one virtual object.

In some embodiments, the first user account casts the first skill in the game battle, and the terminal device determines a to-be-copied virtual object in response to the operation of casting the first skill; and the terminal device performs a mirror operation on the to-be-copied virtual object, to obtain a second virtual object. For example, the second virtual object is of the same type as the to-be-copied virtual object. The level of the second virtual object may be the same as or different from the level of the to-be-copied virtual object.

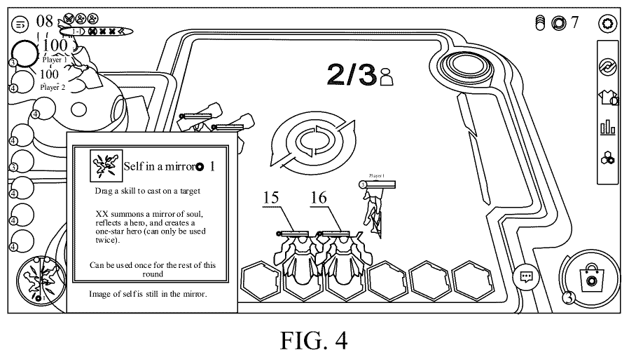

In some embodiments, as shown in FIG. 4, the first user account may mirror a virtual object 15 of the first level through a “mirror” skill to generate another virtual object 16 of the first level. In some embodiments, since the virtual object 16 of the first level is generated by mirroring the virtual object 15 of the first level, the virtual object 16 of the first level is the same as the virtual object 15 of the first level.

Manner 3: Redeem a second voucher for the first virtual object of the first level with probability.

In some embodiments, the second voucher is configured for redeeming for a skill effective in a first time period in the game battle, for example, a skill of enhancing competitiveness of the virtual objects or other virtual objects in the same team. The first time period is any time period in the game battle. For example, the first time period is a round in the game battle.

In some embodiments, the second voucher is configured for redeeming for a lottery skill. For example, the first user account redeems the second voucher for the virtual object, the virtual resource, the first voucher, or other things. The second voucher may be referred to as a talent voucher.

In some embodiments, the second voucher is redeemed for the first virtual object with probability. For example, after the second voucher is used to obtain the lottery skill, the first user account may specify a target virtual object. The target virtual object is a virtual object that the first user account expects to obtain through the lottery skill. The terminal device determines the target virtual object in response to an operation of the first user account indicating a target object; and the terminal device determines a lottery probability of obtaining the target virtual object in response to an operation of obtaining the lottery skill. In a case that the lottery probability of the target virtual object is greater than or equal to a second threshold, the terminal device determines that the first user account obtains the target virtual object. In a case that the lottery probability of the target virtual object is less than the second threshold, the terminal device determines that the first user account cannot obtain the target virtual object through the lottery skill this time, and the first user account can obtain any virtual object other than the first virtual object. The second threshold is set according to an actual requirement, and is not limited in this disclosure. For example, the lottery probability of obtaining the target virtual object may also be determined by the server. The terminal device sends a probability prediction request to the server. The probability prediction request is configured for determining a probability that the first user account uses a redemption skill to obtain the target virtual object this time. The server generates the lottery probability of the target virtual object based on the probability prediction request, and sends the lottery probability of the target virtual object to the terminal device.

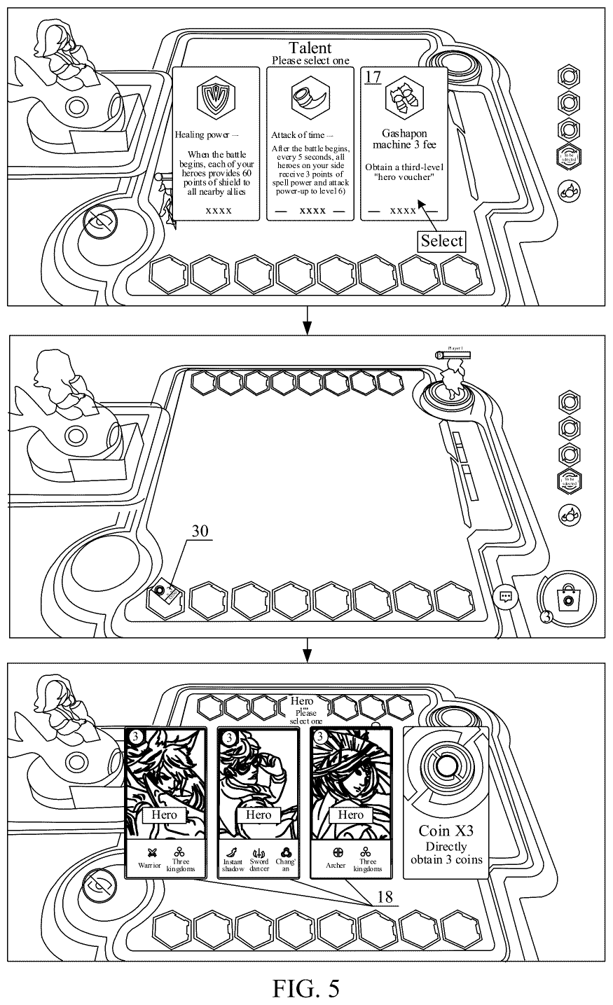

In some embodiments, as shown in FIG. 5, the first user account selects a lottery skill 17 from several skills by using the talent voucher. A first voucher 30 is obtained by using the lottery skill 17. After the first user account uses the first voucher 30, in response to an operation of using the first voucher 30, the terminal device displays a plurality of candidate virtual objects 18 for the user to select. If the candidate virtual object 18 corresponding to the lottery skill 17 includes the first virtual object of the first level, and the first virtual object of the first level is also wanted by the first user account, the first user account selects to redeem for the first virtual object of the first level.

Manner 4: Redeem the first voucher for the first virtual object of the first level with probability.

Related content of the first voucher is described in detail in operation 220 below.

In the foregoing implementation, the virtual object of the first level (for example, the first virtual object of the first level) may be obtained in a variety of manners, thereby enriching manners for the user account to obtain the virtual object of the first level. Moreover, due to independence between the rich obtaining manners, different obtaining methods for obtaining the virtual object of the first level are allowed to be carried by different modules or servers respectively. Therefore, it is helpful to implement distributed deployment of functions of the server or the information display system, and reduce the information processing pressure on the server or the information display system.

Operation 220: In a case that a quantity of first virtual objects of the first level reaches n, display a first voucher and a first virtual object of a second level synthesized based on the n first virtual objects of the first level, n being a positive integer greater than 1.

In some embodiments, if the quantity of first virtual objects of the first level owned by the first user account meets an upgrade condition, the terminal device is triggered to synthesize the n first virtual objects of the first level to obtain a first virtual object of the second level. In some embodiments, the upgrade condition is related to the quantity of first virtual objects of the first level owned by the first user account in the game chess board. For example, the upgrade condition is that the quantity of virtual objects of the first level owned by the first user account reaches n. In another example, the upgrade condition is that a proportion of the quantity of virtual objects of the first level owned by the first user account in all virtual objects owned by the first user account in the game chess board is greater than or equal to a first threshold. For example, the first threshold is a real number in an interval [0, 1]. The first threshold is set according to an actual requirement, and is not limited in this disclosure. In some embodiments, upgrade conditions (for example, a specific value of n) corresponding to different types of virtual objects may be the same or different.

In some embodiments, in a case that the quantity of first virtual objects of the first level reaches n, the n first virtual objects of the first level are automatically synthesized to obtain a first virtual object of the second level. In this way, automatic upgrade of the virtual object is implemented, user operations in the upgrade process of the virtual object are reduced, the user operations are simplified, and a synthesis speed of the virtual object is increased.

To increase the speed of upgrading the first virtual object in the game battle and improve the efficiency of the first user account in completing training of the virtual object in the game battle, in the method provided in this disclosure, in a case that the quantity of first virtual objects of the first level reaches n, in addition to being triggered to synthesize the n first virtual objects of the first level to obtain the virtual object of the second level, the first user account further additionally obtains at least one first voucher.

In some embodiments, the first voucher is configured for redeeming for at least one virtual object or redeeming for virtual resources of a third quantity. In some embodiments, the first voucher is configured for providing at least two candidate virtual objects, and allow the first user account to obtain any virtual object of the at least two candidate virtual objects. In some embodiments, to maintain balance of game mechanics, the virtual resources of the third quantity are equivalent to the candidate virtual objects provided by the first voucher. The first voucher may be referred to as a reward voucher.

In some embodiments, there is an association between the first voucher and the first virtual object. For example, the candidate virtual object provided by the first voucher has the same object attribute as the first virtual object. The object attribute includes, but is not limited to, at least one of the following: a level of the virtual object, a health value of the virtual object, battle power of the virtual object, an evaluation level of the virtual object, or the like. The evaluation level of the virtual object is configured for classifying a plurality of virtual objects supported in the game battle in terms of an impact degree, and the evaluation level of the virtual object may be set by a game developer. For example, if the first virtual object is of the first level, the candidate virtual object is also of the first level. In another example, if the first virtual object is of a first evaluation level, the candidate virtual object is also of the first evaluation level.

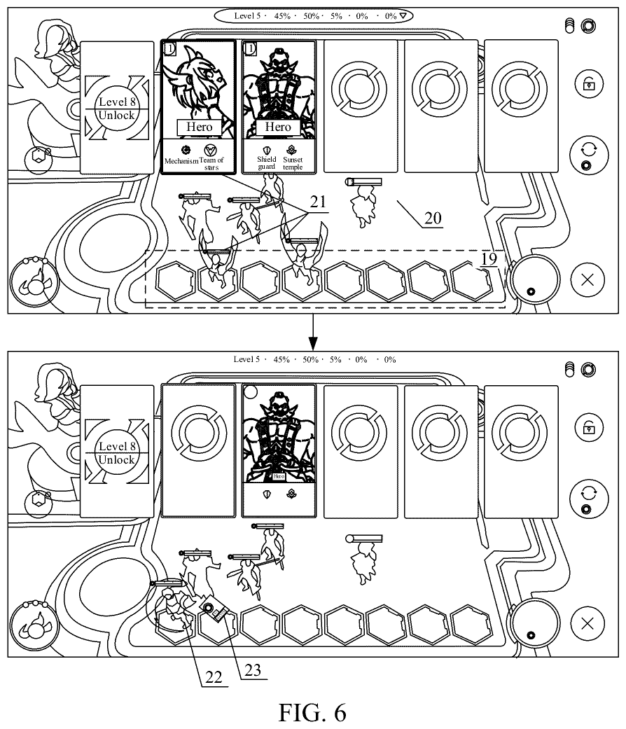

In some embodiments, the terminal device determines a display position of the first voucher in the user interface according to a display position of the first virtual object of the second level in the user interface. In some embodiments, to enhance correlation between a synthesis process of the first virtual object of the second level and the first voucher, a distance between the first virtual object of the second level and the first voucher in the user interface is less than or equal to a distance threshold. The distance threshold is equal to p display positions, p is a positive integer, and the display position is a smallest display unit for displaying the virtual object in the user interface. By controlling the distance between the first virtual object of the second level and the first voucher, it is helpful for the user to notice the synchronously obtained first voucher after completing the synthesis operation on the first virtual object, and it is helpful for the first voucher to participate in the arrangement of the first user account in the game battle in time. In some embodiments, as shown in FIG. 6, the user interface displays a preparation area 19 and a battle area 20. The preparation area 19 is configured for displaying virtual objects waiting to participate in a battle, and the battle area 20 is configured for displaying virtual objects participating in the battle. As shown in FIG. 6, the preparation area 19 includes a plurality of display positions, and the display positions are configured for placing the virtual objects.

Assuming that n is equal to 3, after the first user account owns three virtual objects 21 (namely, 21 in FIG. 6: a virtual object a of a first grade and the first level), the terminal device synthesizes the three virtual objects 21 of the first level to obtain a virtual object 22 of the second level (namely, 22 in FIG. 6: a virtual object a of the first grade and the second level in FIG. 6). In addition, the terminal device displays the additionally obtained first voucher 23 in an available display position adjacent to the virtual object 22 of the second level.

For ease of understanding the correlation between the manner for obtaining the first virtual object and triggering the quantity of virtual objects of the first level owned by the first user account to reach n, an example in which the virtual resource is redeemed for the first virtual object is used for description below. As shown in FIG. 3, after the first user account successfully redeems for a virtual object 14 of the first level in the redemption interface 13, if the available display position exists in the preparation area in the user interface, the terminal device displays the redeemed virtual object 14 of the first level in the available display position in the preparation area. In a case that the quantity of virtual objects 14 of the first level for which the virtual resource is redeemed in the redemption interface 13 meets the upgrade condition (for example, the quantity of virtual objects 14 of the first level reaches three), the three redeemed virtual objects 14 of the first level are synthesized to obtain a virtual object 14 of the second level.

In some embodiments, when the quantity of first virtual objects of the first level reaches n, the terminal device performs the operation of synthesizing the n first virtual objects of the first level to obtain a first virtual object of the second level in response to a synthesis operation (for example, an operation of clicking on a synthesis control) by the user. The first user account may further additionally obtain at least one first voucher while successfully obtaining the first virtual object of the second level through synthesis. The first voucher may be redeemed for the virtual object or the virtual resource. As described above, the virtual resource may be redeemed for the virtual object.

In some possible implementations, before operation 220, the following operations are further included.

1. The terminal device displays upgrade prompt information in a case that the quantity of first virtual objects of the first level meets the upgrade condition, the upgrade prompt information being configured for prompting to upgrade the first virtual object.

2. The terminal device performs the operation of displaying a first voucher and a first virtual object of a second level synthesized based on the n first virtual objects of the first level in response to an upgrade confirmation operation on the upgrade prompt information.

3. The terminal device cancels the display of the upgrade prompt information in a case that the upgrade confirmation operation on the upgrade prompt information is not received within a set duration or a cancellation operation on the upgrade prompt information is received.

In some embodiments, the upgrade prompt information is configured for inquiring, in a case that the quantity of first virtual objects owned reaches n, whether to upgrade the first virtual object of the first level by synthesizing the n first virtual objects of the first level.

The upgrade prompt information may include an upgrade prompt box. In some embodiments, the upgrade prompt box is displayed in a central area of the user interface, to remind the user to pay attention to the upgrade prompt box as much as possible. Alternatively, the upgrade prompt box is displayed in a corner area or an edge area. In this way, the occlusion of display content in the user interface is minimized while the upgrade prompt information is used to inquire whether to upgrade the first virtual object. In some embodiments, the upgrade prompt box includes image information and/or text information, and is configured for prompting that the first virtual object can be synthesized and upgraded.

In some embodiments, the upgrade prompt box further includes an upgrade confirmation control and a cancellation control. The upgrade confirmation control is configured for indicating to confirm the first virtual object of the second level synthesized based on the n first virtual objects of the first level, and a trigger operation on the upgrade confirmation control is the upgrade confirmation operation. The cancellation control is configured for cancelling the display of the upgrade prompt box, that is, the first virtual object of the first level is not upgraded temporarily, and a trigger operation on the cancellation control is the cancellation operation. For example, the trigger operation includes, but is not limited to, at least one of the following: a click operation, a slide operation, a key operation, a voice indication, a gesture operation, or the like.

In some embodiments, the upgrade prompt information includes an upgrade prompt special effect for the n first virtual objects of the first level. The upgrade prompt special effect highlights the first virtual objects of the first level by zooming, flashing, increasing display brightness, or the like, to prompt the user which virtual objects can be currently synthesized for upgrading.

In some embodiments, in response to a trigger operation (for example, an operation such as click, press and hold, or double-click) on any one or more first virtual objects of the first level under the upgrade prompt special effect, the terminal device displays the first virtual object of the second level synthesized based on the n first virtual objects of the first level (that is, completing synthesis and upgrade of the first virtual object), and displays the additionally obtained first voucher.

In this embodiment, in a case that the user interface includes a plurality of first virtual objects of the first level under the upgrade prompt special effect, a virtual object that is most convenient to operate can be selected according to the convenience of the user operation, to perform the trigger operation, to complete the synthesis and upgrade of the virtual object. Compared with triggering a control located at a fixed display position to synthesize and upgrade the virtual object, this embodiment improves the operation convenience and the operation efficiency of the user.

In some embodiments, if the upgrade confirmation operation on the upgrade prompt information is not received within the set duration, it may be considered that the user does not want to synthesize and upgrade the first virtual object, and the terminal device cancels the display of the upgrade prompt information. For example, the terminal device cancels the display of the upgrade prompt box and/or the upgrade prompt special effect, to reduce display resources occupied by the display of the upgrade prompt box and/or the upgrade prompt special effect. While prompting the user to upgrade, it also helps to minimize the occlusion and interference of the upgrade prompt information on interface display content.

In some embodiments, the set duration may be 5 seconds, 8 seconds, 15 seconds, or the like. Specifically, the set duration may be set by relevant technical personnel according to an actual situation. This is not specifically limited in the embodiments of this disclosure.

Operation 230: Display at least two candidate virtual objects in a case that the first voucher is used.

In some embodiments, the candidate virtual object is selected from a virtual object pool based on a set selection rule, and the virtual object pool includes the first virtual object and at least one another virtual object other than the first virtual object.

In some embodiments, the virtual object pool includes at least one virtual object. For example, the virtual object pool includes all virtual objects that can be used in the game battle. For example, the virtual object pool is in a one-to-one correspondence with the virtual object, or a plurality of virtual objects share one virtual object pool, or the virtual objects included in the virtual object pool are preset by the first user account.

In some embodiments, the selection rule is configured for determining the candidate virtual object from the virtual object pool. For example, the selection rule is configured for determining another virtual object having similarities with the first virtual object from the virtual object pool as the candidate virtual object. For example, the terminal device selects at least one candidate virtual object from the virtual object pool according to the selection rule and the first virtual object. The set selection rule may be preset by the game developer, or may be selected from a plurality of candidate selection rules in the game battle by at least one user account participating in the game battle by voting or the like. This is not limited herein.

In some implementations, the set selection rule includes at least the following.

(1) A grade of the candidate virtual object is the same as a grade of the first virtual object.

The grade is configured for representing a battle ability of the virtual object in the auto chess game.

In some embodiments, the virtual objects may be divided into different grades according to their battle abilities, such as a first grade, a second grade, a third grade, a fourth grade, and a fifth grade. In the case of the same level, a virtual object of a higher grade has a higher battle ability. The first voucher also has a corresponding grade. In some embodiments, the grade of the first voucher affects the grade of the virtual object for which the first voucher is redeemed. For example, the grade of the redeemed virtual object is the same as the grade of the first voucher.

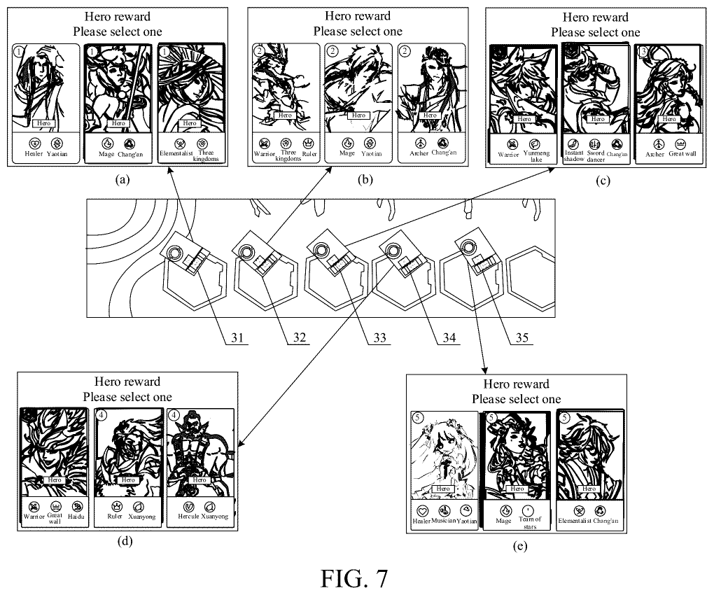

As shown in FIG. 7, the first voucher may include a first voucher 31 of the first grade (corresponding to the virtual object of the first grade in 7(a)), a first voucher 32 of the second grade (corresponding to the virtual object of the second grade in 7(b)), a first voucher 33 of the third grade (corresponding to the virtual object of the third grade in 7(c)), a first voucher 34 of the fourth grade (corresponding to the virtual object of the fourth grade in 7(d)), and a first voucher 35 of the fifth grade (corresponding to the virtual object of the fifth grade in 7(e)).

(2) A rare level of the candidate virtual object is the same as a rare level of the first virtual object.

The rare level is configured for representing a rareness of the virtual object. In some embodiments, the rareness is represented by an obtaining probability of the virtual object in the game battle. A higher obtaining probability indicates that the virtual object is less difficult to obtain in the game battle, that is, the virtual object is not rare; and a lower obtaining probability indicates that the virtual object is more difficult to obtain in the game battle, that is, the virtual object is rare. The obtaining probability may be preset, or may be determined by counting occurrence frequencies of the virtual objects in a plurality of game battles.

In some embodiments, different virtual objects have different rarenesses. Some virtual objects have a higher obtaining probability, and some virtual objects have a lower obtaining probability. The rareness may be represented by a rare level. A higher rare level indicates a higher rareness; and a lower rare level indicates a lower rareness. The rare level of the candidate virtual object is the same as the rare level of the first virtual object, that is, the rareness of the candidate virtual object and the rareness of the first virtual object are the same or similar.

(3) A function type of the candidate virtual object is the same as a function type of the first virtual object.

The function type is configured for representing a function of the virtual object in the auto chess game.

In some embodiments, the virtual objects in the auto chess game have a variety of function types, such as assassin, healer, mage, and archer. Different function types have their own functional features and skills they specialize in. In some embodiments, the candidate virtual object has the same function type as the first virtual object. For example, if the function type of the first virtual object is a healer, the function type of the corresponding candidate virtual object is also a healer.

In the foregoing implementation, the candidate virtual object has the same grade or rareness or function type as the first virtual object, and which virtual objects are of the same grade or rareness or function type are known. Therefore, before synthesizing a virtual object of a higher level, the user knows which virtual objects the obtained first voucher can be redeemed for, so that the first voucher may be used in a planned way. In this way, randomness of the candidate virtual object corresponding to the first voucher is reduced, thereby helping the user make a strategy for synthesizing required virtual objects with reference to the set selection rule, and shortening the cycle of leveling up the virtual object, to maximize the efficiency of enhancing the battle power of the user account in the auto chess game.

In some embodiments, the terminal device determines all virtual objects meeting the set selection rule in the virtual object pool as candidate virtual objects and displays the candidate virtual objects, or the terminal device selects, based on a random algorithm, some virtual objects from the virtual objects meeting the set selection rule as candidate virtual objects.

In some embodiments, the virtual object pool includes a plurality of virtual objects meeting the selection rule, but in a case that the first voucher is used, the displayed candidate virtual objects are only some of the plurality of virtual objects meeting the selection rule. For example, the virtual object pool includes 20 virtual objects meeting the selection rule, but each time the first voucher is used, only three candidate virtual objects can be displayed for selection. The candidate virtual objects may be selected from the virtual objects meeting the selection rule based on a random algorithm model. In some embodiments, the random algorithm model is configured for generating a random number, and a virtual object corresponding to the generated random number is used as a candidate virtual object. A type of the random algorithm model is set according to an actual requirement, and is not limited in this disclosure.

In some embodiments, there is at least one third virtual object in the at least two candidate virtual objects. The third virtual object, together with the obtained virtual objects of the first user account, has a possibility of being synthesized to obtain a virtual object of a higher level. The obtained virtual object of the first user account includes, but is not limited to, at least one of the following: owned virtual objects, virtual objects deployed in the preparation area, and virtual objects deployed in the battle area. That is, there is at least one third virtual object in the at least two candidate virtual objects, and the obtained virtual objects of the first user account include the at least one third virtual object. If the first user account redeems the first voucher for such candidate virtual objects, a quantity of third virtual objects owned by the first user account meets the upgrade condition, and upgrade of the third virtual object is completed through the first voucher. By determining the obtained virtual objects of the user account as the candidate virtual objects, it is helpful to increase the speed of synthesizing and upgrading the virtual objects of the user account, thereby improving the efficiency of synthesizing and upgrading the virtual objects, and further improving the efficiency of enhancing the overall battle power of the first user account.

For example, if the obtained virtual objects of the first user account include: a virtual object A of the first level, a virtual object B of the first level, a virtual object C of the first level, a virtual object D of the first level, and a virtual object E of the first level. In this case, after the first user account uses the first voucher, the at least two candidate virtual objects displayed by the terminal device include at least one of the virtual object A of the first level, the virtual object B of the first level, the virtual object C of the first level, the virtual object D of the first level, or the virtual object E of the first level.

In another example, the obtained virtual objects of the first user account include: the virtual object A of the first level, the virtual object B of the first level, the virtual object C of the first level, the virtual object D of the first level, and the virtual object E of the first level, but only the virtual object A of the first level, the virtual object B of the first level, and the virtual object C of the first level are deployed in the preparation area. In this case, after the first user account uses the first voucher, the at least two candidate virtual objects displayed by the terminal device include at least one of the virtual object A of the first level, the virtual object B of the first level, or the virtual object C of the first level.

In another example, the obtained virtual objects of the first user account include: the virtual object A of the first level, the virtual object B of the first level, the virtual object C of the first level, the virtual object D of the first level, and the virtual object E of the first level, but only the virtual object A of the first level, the virtual object B of the first level, and the virtual object D of the first level are deployed in the battle area. In this case, after the first user account uses the first voucher, the at least two candidate virtual objects displayed by the terminal device include at least one of the virtual object A of the first level, the virtual object B of the first level, or the virtual object D of the first level.

In another example, the first user account already owns the virtual object A of the first level, the virtual object B of the first level, the virtual object C of the first level, the virtual object D of the first level, and the virtual object E of the first level, but only the virtual object B of the first level and the virtual object C of the first level are deployed in the preparation area, and only the virtual object D of the first level is deployed in the battle area. In this case, after the first user account uses the first voucher, the at least two candidate virtual objects displayed by the terminal device include at least one of the virtual object B of the first level, the virtual object C of the first level, or the virtual object D of the first level.

Further, in some embodiments, in the virtual objects meeting the selection rule corresponding to the first voucher, a virtual object with a smallest quantity difference (the quantity difference is not 0) between a quantity of obtained virtual objects of the first user account and a quantity required to reach the upgrade condition is preferentially determined as a candidate virtual object. For example, if the difference between the quantity of third virtual objects of the first level owned by the first user account and the quantity required to meet the upgrade condition is one, and the third virtual object meets the selection rule corresponding to the first voucher (for example, the third virtual object has the same grade as the first voucher), a third virtual object of the first level is preferentially displayed in the candidate virtual objects.

In this embodiment, by preferentially determining the virtual object with the smallest difference from the upgrade condition as the candidate virtual object, the possibility that the user account can successfully upgrade the virtual object after using the first voucher is maximized, thereby further improving the upgrade efficiency of the virtual object, and further improving the efficiency of enhancing the overall battle power of the first user account. In addition, the impact of the first voucher on the current configuration of the virtual object is further improved. In the foregoing embodiments, by limiting the quantity of displayed candidate virtual objects, the candidate virtual objects can be clearly displayed in the user interface. Moreover, since the user no long needs to select from excessive virtual objects, the time required for the user to select a virtual object is reduced, the selection efficiency is improved, the pace of the game is accelerated, and the overall time required to finish the auto chess game is reduced.

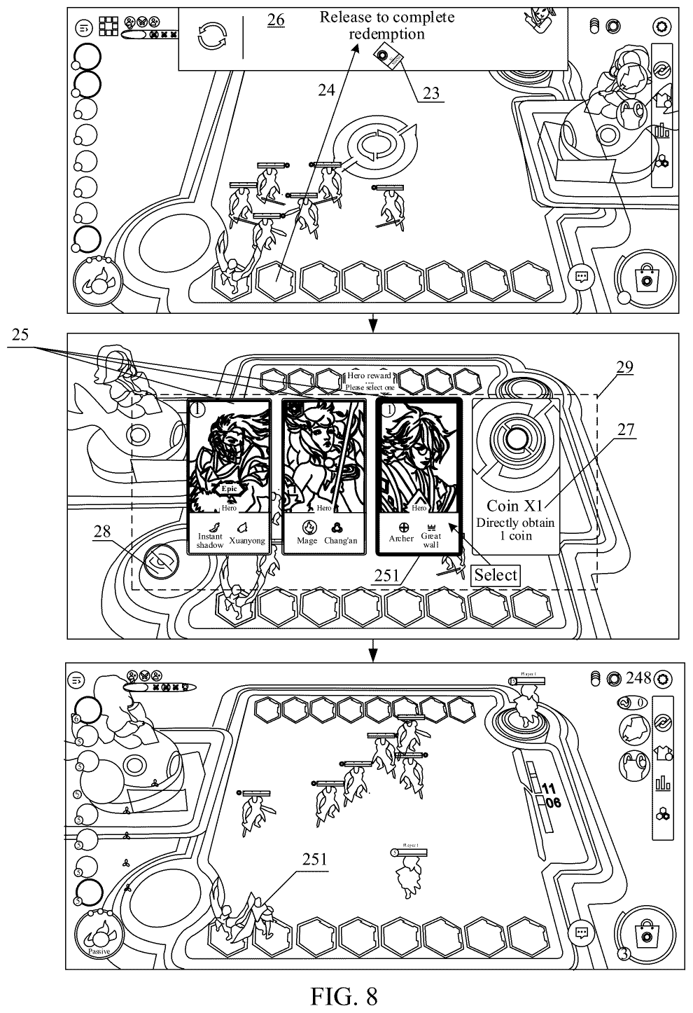

In some embodiments, as shown in FIG. 8, after displaying the additionally obtained first voucher 23 at the available display position, the terminal device displays a plurality of candidate virtual objects 25 in response to a redemption operation 24 on the first voucher 23. In some embodiments, the plurality of candidate virtual objects 25 are different from each other, but all of the first grade like the first virtual object. In some embodiments, as shown in FIG. 8, the redemption operation 24 is an operation of moving the first voucher 23 to a target area 26 and then releasing.

In some possible implementations, as shown in FIG. 8, the terminal device displays a redemption interface 29 corresponding to the first voucher. The redemption interface 29 displays at least two candidate virtual objects; and the redemption interface 29 further displays at least one of the following: an option 27 for a virtual resource, or a delay selection control 28. The virtual resource is configured for redeeming for a virtual item used in the auto chess game, and the delay selection control 28 is configured for retracting the redemption interface.

In some embodiments, the redemption interface further displays options respectively corresponding to the at least two candidate virtual objects, and the option is configured for indicating to redeem for a candidate virtual object corresponding to the option.

In this implementation, by displaying the virtual resource in the redemption interface 29, the user is provided with other options than the candidate virtual objects. By displaying the delay selection control in the redemption interface 29, the user may have more time to think and better determine which option to select, thereby minimizing a probability that the user selects an unsatisfactory option, and helping to enhance the battle power of the first user account in the auto chess game. In some embodiments, after being retracted, the redemption interface is displayed in a corner (such as a lower left corner or a lower right corner) or a side area (such as a left side or a right side) of the user interface, to reduce the occlusion of other display content in the user interface.

In some possible implementations, in response to a refresh operation (for example, clicking on a control corresponding to the refresh operation), the terminal device updates and displays the candidate virtual object in the redemption interface. Therefore, when the user is dissatisfied with the candidate virtual object currently displayed in the redemption interface, an opportunity to replace the candidate displayed object may be obtained by refreshing the redemption interface, thereby improving a probability that the user selects a satisfactory candidate virtual object, and further enhancing the battle power of the first user account in the auto chess game.

In some embodiments, the terminal device uses the random algorithm on all virtual objects in the virtual object pool that meet a condition (for example, meet the selection rule), re-selects at least two virtual objects as candidate virtual objects, and displays the candidate virtual objects in the redemption interface. In this case, there may be duplicate candidate virtual objects before and after the redemption interface is refreshed. Updating the candidate virtual object by using the random algorithm ensures randomness of the virtual objects displayed in the redemption interface.

In some embodiments, the candidate virtual object displayed in the refreshed redemption interface is completely different from the candidate virtual object displayed previously. That is, in a process of using a specific first voucher, the virtual object that has been displayed in the redemption interface is not redisplayed, that is, the candidate virtual object is not repeatedly displayed as much as possible. When the user selects to refresh the redemption interface, it indicates that the user is dissatisfied with all virtual objects displayed in the redemption interface. If these displayed virtual objects are redisplayed, there is a high probability that the user is still dissatisfied. Therefore, as different virtual objects as possible are displayed for each refresh, further improving the probability that the user selects a satisfactory virtual object from the redemption interface, and further enhancing the battle power of the first user account in the auto chess game.

In some embodiments, the virtual resource needs to be consumed to obtain the number of refreshes (that is, the number of times that the refresh operation is performed to refresh the candidate virtual object displayed in the redemption interface), which is paid refresh. Alternatively, the user may obtain free refreshes by completing related tasks. In some embodiments, there is a limit to the number of refreshes corresponding to a first voucher and/or the number of refreshes corresponding to all first vouchers, and the user cannot refresh the redemption interface an unlimited number of times. For example, each first voucher and/or all first vouchers correspond to a maximum number of refreshes. If the maximum number of refreshes is exceeded, the redemption interface can no longer be refreshed. By limiting the number of refreshes, the number of times the user refreshes the redemption interface can be limited, thereby controlling a frequency at which the terminal device or the server processes a refresh request, and reducing the data processing pressure on the terminal device or the server. In addition, since the number of refreshes is limited, the user does not refresh the redemption interface frequently, thereby reducing the time required for the user to select the virtual object from the redemption interface, improving selection efficiency, and further improving game efficiency.

Operation 240: In response to a selection operation on a second virtual object of the at least two candidate virtual objects, display the second virtual object obtained by the first user account.

In some embodiments, if the selection operation on the second virtual object of the at least two candidate virtual objects is received, it indicates that it is determined to redeem the first voucher for the second virtual object, and prompt information is displayed to prompt successful redemption of the second virtual object. In some embodiments, the second virtual object may be the first virtual object, such as the first virtual object of the first level; and the second virtual object may also be another virtual object other than the first virtual object, for example, another virtual object of the first level.

In some embodiments, as shown in FIG. 8, in response to a selection operation on a virtual object 251 of the at least two candidate virtual objects 25, it is determined to redeem the first voucher 23 for the virtual object 251. The virtual object 251 is, like the virtual object 14 corresponding to the first voucher 23 (because the first voucher 23 is an award obtained when the three virtual objects 14 of the first level are synthesized to obtain the virtual object of the second level), a virtual object of the first grade and the first level.

In some embodiments, the second virtual object may be configured for synthesizing a second virtual object of a higher level. For example, the second virtual object is the first virtual object of the first level, and may be jointly referred to as another first virtual objects of the second level together with other first virtual objects of the first level.

In some embodiments, in a process of upgrading the virtual object from the second level to the third level or a virtual object of another level, reference may be made to related content of upgrading the virtual object from the first level to the second level. Details are not described herein again.

In conclusion, when a virtual object of a higher level is obtained by synthesizing n virtual objects of the same type and the same level, an additionally obtained voucher is displayed. When completing synthesis and upgrade of the virtual objects, a user account can obtain not only a virtual object whose level has been increased by synthesizing the virtual objects, but also another virtual object by using the additionally obtained voucher. By redeeming the voucher for the virtual object, it is helpful to continue to help the user account upgrade the obtained virtual object, improve the speed of upgrading the virtual object in the auto chess game, and quickly enhance the overall battle power of the user account, that is, improve the efficiency of enhancing the battle power of the user account in the auto chess game.

In addition, it is helpful to accelerate the pace of the game, shorten the duration of the game battle, and reduce power consumption of running the terminal device. Moreover, increasing a quantity of user accounts waiting to be matched at the same time helps reduce the calculation pressure on the server in matching the user accounts to an appropriate game battle.

In some possible implementations, the user interface displays a preparation area and a battle area, the preparation area is configured for displaying virtual objects waiting to participate in a battle, and the battle area is configured for displaying virtual objects participating in the battle. The displaying the additionally obtained first voucher (that is, the foregoing operation 220) includes the following several operations.

1. In a case that an available display position exists in the preparation area, display the first voucher at the available display position in the preparation area.

2. Display the first voucher in the battle area in a case that no available display position exists in the preparation area and the first user account is in a preparation state.

In some embodiments, the preparation state is a state in which a battle has not started and the first user account is in a battle preparation stage. Regardless of whether the first user account is in the preparation state, in a case that the available display position exists in the preparation area, the terminal device preferentially displays the first voucher in the preparation area. Therefore, the first user account can conveniently use the first voucher when needed, thereby improving the convenience of the first user account in laying out the virtual objects owned.

In some embodiments, in a case that no available display position exists in the preparation area, the first user account is in the preparation state, and the battle area has no other use for the time being, the terminal device displays the first voucher in the battle area, thereby fully utilizing the display space of the user interface and improving the utilization of the user interface.

In some embodiments, in a case that no available display position exists in the preparation area and the first user account is in a battle state, the first voucher is automatically used. The terminal device performs the operation of displaying the at least two candidate virtual objects.

If no available display position exists in the preparation area, and the first user account is in the battle state, in this case, neither the preparation area nor the battle area can accommodate the display of the first voucher. In this case, operation 230 may be performed. That is, the terminal device automatically triggers the use of the first voucher and displays the at least two candidate virtual objects. If one of the at least two candidate virtual objects, together with a quantity of virtual objects of the same type currently owned by the first user account can meet the upgrade condition, one of the candidate virtual objects may be selected to be redeemed and synthesized together with the virtual objects of the same type that are owned into a virtual object of a higher level.

For example, a condition for upgrading the virtual object A of the first level to the second level is that the quantity reaches three, and there are already two virtual objects A of the first level in the preparation area; and there is a virtual object A of the first level in the at least two candidate virtual objects displayed after the first voucher is used. In this case, the virtual object A of the first level and the two virtual objects A of the first level in the preparation area may be synthesized into a virtual object A of the second level.

In this way, a problem of placing the first voucher is resolved; and the automatically used voucher is configured with probability for upgrading an obtained virtual object of the user, and can further enhance the battle power of the first user account in the auto chess game. In addition, in a case that the first voucher cannot be placed in either the preparation area or the battle area, the voucher may be automatically opened for the user to use immediately, thereby avoiding the waste of the voucher obtained by synthesizing the virtual objects due to limited display positions in the user interface.

In some embodiments, after the first voucher is displayed in the battle area, in a case that the available display position exists in the preparation area, the first voucher is moved from the battle area to the available display position in the preparation area for display. That is, even if the first voucher is displayed in the battle area because there are no available display positions in the preparation area for the time being, as long as there is an available display position in the preparation area, the first voucher in the battle area is moved to the available display position in the preparation area for display, thereby making full use of the display position in the preparation area as much as possible, improving the utilization of the display position in the preparation area, and reducing the occlusion of the battle area.

In the foregoing implementation, by displaying the voucher in the preparation area as much as possible, it is helpful to improve the convenience of the first user account in laying out the virtual objects owned.

In the foregoing implementation, in a case that no available display position exists in the preparation area and the first user account is in the battle state, the first voucher is used, and the operation of displaying the at least two candidate virtual objects is performed. In this way, the problem of placing the first voucher is resolved. In addition, the display positions are freed up as much as possible, the need for the available display positions in the preparation area is alleviated, the available display positions in the preparation area are saved, and the battle power of the first user account in the auto chess game is enhanced.

In the foregoing implementation, after the first voucher is displayed in the battle area, in a case that the available display position exists in the preparation area, the first voucher is moved from the battle area to the available display position in the preparation area for display, thereby making full use of the display position in the preparation area as much as possible, improving the utilization of the display position in the preparation area, and minimizing the occlusion of the battle area.

In some possible implementations, the user interface displays a preparation area and a battle area, the preparation area is configured for displaying virtual objects waiting to participate in a battle, and the battle area is configured for displaying virtual objects participating in the battle. The displaying the second virtual object obtained by the first user account (that is, the foregoing operation 240) includes the following operations:
1. Display the second virtual object obtained by the first user account at the available display position in the preparation area in a case that the available display position exists in the preparation area.
2. Display the second virtual object obtained by the first user account in a temporary preparation area of the user interface in a case that no available display position exists in the preparation area and the first user account is in a preparation state, the temporary preparation area being configured for displaying virtual objects that cannot be displayed in the preparation area due to on a quantity limitation of the available display positions.

In some embodiments, if the available display position exists in the preparation area, the terminal device displays the second virtual object obtained by the first user account at the available display position in the preparation area. That is, the virtual object is preferentially displayed at a display position in the preparation area. In this way, the utilization of the display position in the preparation area is improved. In addition, it is convenient for the user to arrange (lay out) the virtual objects owned, which improves the preparation convenience and preparation efficiency of the user.

In some embodiments, if no available display position exists in the preparation area and the first user account is in the preparation state, the second virtual object can only be displayed in another area. Since the virtual object in the preparation state cannot be displayed in the battle area, the second virtual object can only be displayed in the temporary preparation area. The temporary preparation area is an area different from the preparation area and the battle area. The temporary preparation area may be located in an edge area of the user interface, such as a left edge area, a right edge area, a top area, and a bottom area. In some embodiments, after the second virtual object is reduced in size, the second virtual object is displayed in the temporary preparation area, to save the display space of the temporary preparation area and improve a quantity of virtual objects that can be accommodated in the temporary preparation area.

In some embodiments, in a case that no available display position exists in the preparation area and the first user account is in the battle state, battle prompt information is displayed. The battle prompt information is configured for indicating that the first user account is currently in the battle state, and the candidate virtual object is selected after the battle state ends. That is, if no available display position exists in the preparation area and the first user account is in the battle state, the first voucher cannot be redeemed for any virtual object, that is, the first voucher cannot be redeemed for the virtual object for the time being, thereby resolving a problem of excessive virtual objects that have no position to place, and avoiding confusing display in the user interface.

In the foregoing implementation, in a case that the available display position exists in the preparation area, the second virtual object obtained by the first user account is displayed at the available display position in the preparation area, which improves the utilization of the display position in the preparation area. In addition, it is convenient for the user to arrange the virtual objects owned, which improves the preparation convenience and preparation efficiency of the user.

In some possible implementations, the user interface displays a preparation area and a battle area, the preparation area is configured for displaying virtual objects waiting to participate in a battle, and the battle area is configured for displaying virtual objects participating in the battle. The method further includes:

after the first user account obtains a first voucher, if the first voucher is displayed in the preparation area, compared with other virtual objects, there is a higher probability that a candidate virtual object displayed when the first voucher is redeemed is the same as the virtual object in the preparation area. In other words, there is a higher probability that the candidate virtual object displayed in the redemption interface can be synthesized with the virtual object deployed by the first user account in the preparation area to obtain a virtual object of a higher level. That is, there is a higher probability that the candidate virtual object is the same as the virtual object deployed by the first user account in the preparation area. For example, it is assumed that based on the random algorithm, a probability that the candidate virtual object is the same as the virtual object in the preparation area is a; and based on this embodiment, the probability that the candidate virtual object is the same as the virtual object in the preparation area increases to b, a is less than b, and a and b are positive integers. For example, a is 0.1 and b is 0.5.

After the first user account obtains a first voucher, if the first voucher is displayed in the battle area, compared with other virtual objects, there is a higher probability that a candidate virtual object displayed when the first voucher is redeemed is the same as the virtual object in the battle area. In other words, there is a higher probability that the candidate virtual object displayed in the redemption interface can be synthesized with the virtual object deployed by the first user account in the battle area to obtain a virtual object of a higher level. That is, there is a higher probability that the candidate virtual object is the same as the virtual object deployed by the first user account in the battle area.

In the foregoing embodiment, whether the first voucher is displayed in the preparation area or the battle area before being used affects a corresponding candidate virtual object displayed after the first voucher is used. The candidate virtual object corresponding to the first voucher opened in the preparation area fits the virtual object lineup in the preparation area as closely as possible; and the candidate virtual object corresponding to the first voucher opened in the battle area fits the virtual object lineup in the battle area as closely as possible. If the user wants the candidate virtual object corresponding to the first voucher to fit the virtual object in that area, the user may move the first voucher to the corresponding area through a movement operation before the first voucher is used, thereby improving a probability that the candidate virtual object opened in the first voucher matches the user's preference, and further improving the efficiency of enhancing the battle power of the user account in the auto chess game.

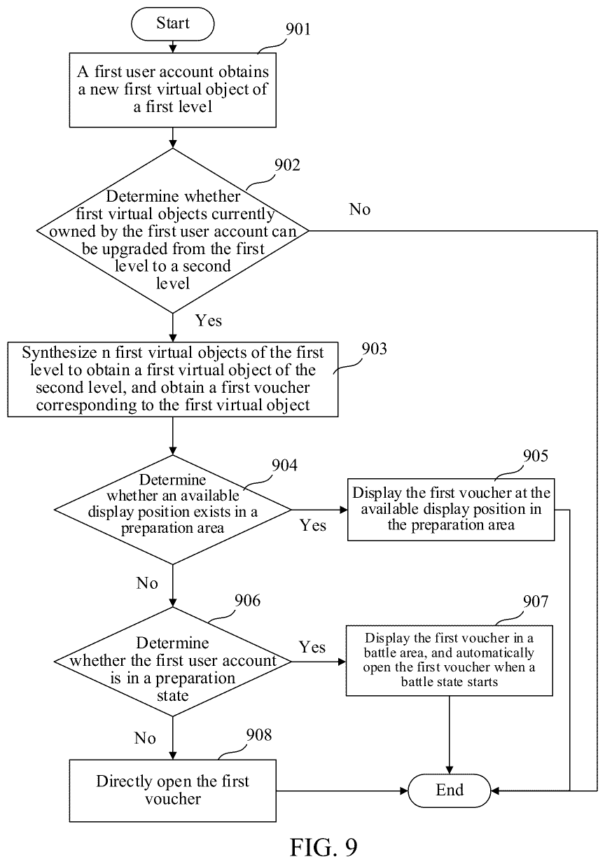

In some embodiments, as shown in FIG. 9, the information display method includes the following operations (901 to 908).

Operation 901: A first user account obtains a new first virtual object of a first level.

Operation 902: A terminal device determines whether first virtual objects currently owned by the first user account can be upgraded from the first level to a second level. If yes, perform the following operation 904; or if no, the operation ends.

Operation 903: The terminal device synthesizes n first virtual objects of the first level to obtain a first virtual object of a second level, and the first user account obtains a first voucher corresponding to the first virtual object.

Operation 904: The terminal device determines whether an available display position exists in a preparation area. If yes, perform the following operation 905; or if no, perform the following operation 906.

Operation 905: The terminal device displays the first voucher at the available display position in the preparation area.

Operation 906: The terminal device determines whether the first user account is in a preparation state. If yes, perform the following operation 907; or if no, perform the following operation 908.

Operation 907: The terminal device displays the first voucher in a battle area, and automatically opens the first voucher when a battle state starts.

Operation 908: The terminal device directly opens the first voucher.

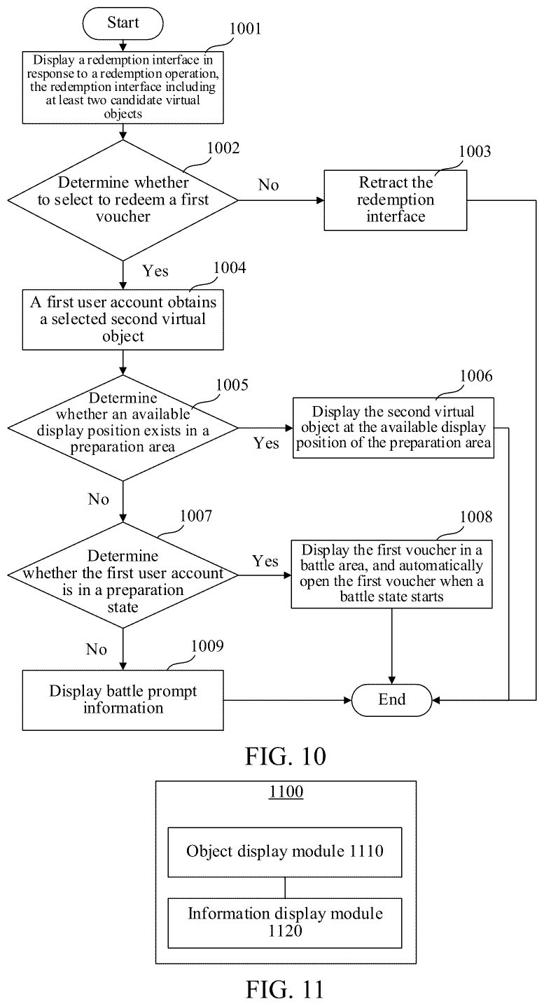

In some embodiments, as shown in FIG. 10, a method for using the first voucher includes the following operations (1001 to 1009).

Operation 1001: The terminal device displays a redemption interface in response to a redemption operation, the redemption interface including at least two candidate virtual objects.

Operation 1002: The terminal device determines whether to select to redeem the first voucher. If yes, perform the following operation 1004; or if no, perform the following operation 1003.

Operation 1003: The terminal device closes the redemption interface.

Operation 1004: The first user account obtains a selected second virtual object.

Operation 1005: The terminal device determines whether an available display position exists in a preparation area. If yes, perform the following operation 1006; or if no, perform the following operation 1007.

Operation 1006: The terminal device displays the second virtual object at the available display position in the preparation area.

Operation 1007: The terminal device determines whether the first user account is in a preparation state. If yes, perform the following operation 1008; or if no, perform the following operation 1009.

Operation 1008: The terminal device displays the first voucher in a battle area, and automatically opens the first voucher when a battle state starts.

Operation 1009: The terminal device displays battle prompt information.

The battle prompt information is configured for indicating that the first user account is currently in the battle state, and the candidate virtual object is selected after the battle state ends.

The following is an apparatus embodiment of this disclosure, which can be used to perform the method embodiments of this disclosure. For details not disclosed in the apparatus embodiment of this disclosure, refer to the method embodiments of this disclosure.

FIG. 11 is a block diagram of an information display apparatus according to an embodiment of this disclosure. The apparatus has a function of implementing the above information display method example, and the function may be achieved by hardware or by hardware executing corresponding software. The apparatus may be the terminal device described above, or may be disposed on the terminal device. The apparatus 1100 may include: an object display module 1110 and an information display module 1120.

The object display module 1110 is configured to display a first virtual object of a first level owned by a first user account in a user interface of an auto chess game.

The object display module 1110 is further configured to: in a case that a quantity of first virtual objects of the first level reaches n, display a first voucher and a first virtual object of a second level synthesized based on the n first virtual objects of the first level, n being a positive integer greater than 1.

The object display module 1110 is further configured to display at least two candidate virtual objects in a case that the first voucher is used.

The information display module 1120 is configured to: in response to a selection operation on a second virtual object of the at least two candidate virtual objects, display the second virtual object obtained by the first user account.

In some embodiments, the object display module 1110 is configured to: display a redemption interface corresponding to the first voucher; and display the at least two candidate virtual objects in the redemption interface; and the redemption interface further displays at least one of the following: an option for a virtual resource, or a delay selection control, where the virtual resource is configured for redeeming for a virtual item used in the auto chess game, and the delay selection control is configured for retracting the redemption interface.

In some embodiments, the user interface displays a preparation area and a battle area, the preparation area is configured for displaying virtual objects waiting to participate in a battle, and the battle area is configured for displaying virtual objects participating in the battle; and the object display module 1110 is configured to: in a case that an available display position exists in the preparation area, display the first voucher at the available display position in the preparation area; and display the first voucher in the battle area in a case that no available display position exists in the preparation area and the first user account is in a preparation state.

In some embodiments, the first voucher is used in a case that no available display position exists in the preparation area and the first user account is in a battle state.

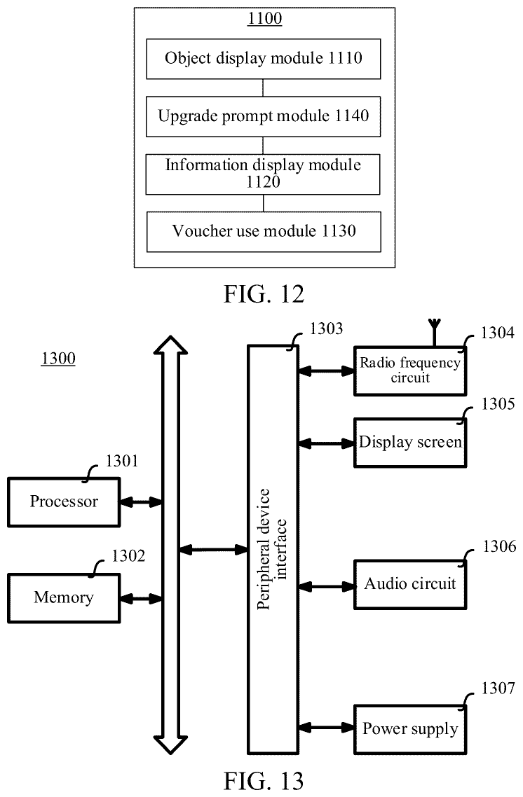

In some embodiments, as shown in FIG. 12, the apparatus further includes: a voucher use module 1130, configured to move the first voucher from the battle area to the available display position in the preparation area for display in a case that the available display position exists in the preparation area.

In some embodiments, the user interface displays a preparation area and a battle area, the preparation area is configured for displaying virtual objects waiting to participate in a battle, and the battle area is configured for displaying virtual objects participating in the battle; and the information display module 1120 is configured to: display the second virtual object obtained by the first user account at the available display position in the preparation area in a case that the available display position exists in the preparation area; and display the second virtual object obtained by the first user account in a temporary preparation area of the user interface in a case that no available display position exists in the preparation area and the first user account is in a preparation state, the temporary preparation area being configured for displaying virtual objects that cannot be displayed in the preparation area due to a quantity limitation of the available display position.

In some embodiments, the information display module 1120 is further configured to display battle prompt information in a case that no available display position exists in the preparation area and the first user account is in a battle state, the battle prompt information being configured for indicating that the first user account is currently in the battle state, and the candidate virtual object being selected after the battle state ends.

In some embodiments, the candidate virtual object is selected from a virtual object pool based on a set selection rule, and the virtual object pool includes the first virtual object and at least one another virtual object other than the first virtual object.

In some embodiments, a grade of the candidate virtual object is the same as a grade of the first virtual object, and the grade is configured for representing a battle ability of the virtual object in the auto chess game; or a rare level of the candidate virtual object is the same as a rare level of the first virtual object, and the rare level is configured for representing a rareness of the virtual object; or a function type of the candidate virtual object is the same as a function type of the first virtual object, and the function type is configured for representing a function of the virtual object in the auto chess game.

In some embodiments, the first virtual object of the first level is obtained in at least one of the following manners: redeeming the virtual resource for the first virtual object of the first level; obtaining the first virtual object of the first level by using a skill; redeeming the first voucher for the first virtual object of the first level with probability; and redeeming a second voucher for the first virtual object of the first level with probability.

In some embodiments, as shown in FIG. 12, the apparatus further includes: an upgrade prompt module 1140, configured to: display upgrade prompt information in a case that the quantity of first virtual objects of the first level reaches n, the upgrade prompt information being configured for prompting to upgrade the first virtual object; perform the operation of displaying a first voucher and a first virtual object of a second level synthesized based on the n first virtual objects of the first level in response to an upgrade confirmation operation on the upgrade prompt information; and cancel the display of the upgrade prompt information in a case that the upgrade confirmation operation on the upgrade prompt information is not received within a set duration or a cancellation operation on the upgrade prompt information is received.

When the apparatus provided in the foregoing embodiments implements functions of the apparatus, the division of the foregoing functional modules is merely an example for description. The foregoing function allocation is completed by different functional modules according to needs, that is, the internal structure of the device is divided into different functional modules, to complete all or some of functions described above. In addition, the apparatus provided in the foregoing embodiments and the method embodiments belong to the same conception. For the specific implementation process, refer to the method embodiments, and details are not described herein again. Beneficial effects of the apparatus embodiment are the same as those of the method embodiments, and details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 13 is a structural block diagram of a terminal device 1300 according to an embodiment of this disclosure. The terminal device 1300 may be an electronic device such as a mobile phone, a tablet computer, a game console, an ebook reader, a multimedia playback device, a wearable device, or a PC. The terminal device is configured to implement the information display method provided in the foregoing embodiments. The terminal device may be the terminal device 11 in the implementation environment shown in FIG. 1. Specifically,
generally, the terminal device 1300 includes: a processor 1301 and a memory 1302.

Processing circuitry, such as the processor 1301 may include one or more processing cores, such as a 4-core processor or an 8-core processor. The processor 1301 may be implemented by using at least one hardware form of a digital signal processing (DSP), a field programmable gate array (FPGA), or a programmable logic array (PLA). The processor 1301 may also include a main processor and a coprocessor. The main processor is configured to process data in an active state, also referred to as a central processing unit (Central Processing Unit, CPU). The coprocessor is a low-power consumption processor configured to process data in a standby state. In some embodiments, the processor 1301 may be integrated with a graphics processing unit (GPU). The GPU is configured to be responsible for rendering and drawing content that needs to be displayed in a display. In some embodiments, the processor 1301 may alternatively include an artificial intelligence (AI) processor. The AI processor is configured to process a computing operation related to machine learning.

The memory 1302, such as a non-transitory computer-readable storage medium, may include one or more computer-readable storage media that may be non-transitory. The memory 1302 may further include a high-speed random access memory, and a non-volatile memory, for example, one or more disk storage devices and flash storage devices. In some embodiments, the non-transitory computer-readable storage medium in the memory 1302 is configured to store a computer program, the computer program being configured to be executed by one or more processors to implement the foregoing information display method.

In some embodiments, the terminal device 1300 may further include: a peripheral interface 1303 and at least one peripheral device. The processor 1301, the memory 1302, and the peripheral interface 1303 may be connected through a bus or a signal cable. Each peripheral device may be connected to the peripheral interface 1303 by using a bus, a signal cable, or a circuit board. Specifically, the peripheral device includes: at least one of a radio frequency circuit 1304, a display screen 1305, an audio circuit 1306, or a power supply 1307.

A person skilled in the art may understand that the structure shown in FIG. 13 constitutes no limitation to the terminal device 1300, and the terminal device may include more or fewer components than those shown in the figure, or some components may be combined, or a different component arrangement may be used. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In an example, a computer-readable storage medium such as a non-transitory computer-readable storage medium is further provided. The storage medium has a computer program stored therein, the computer program, when executed by a processor, implementing the foregoing information display method.

In some embodiments, the computer-readable storage medium may include: a read-only memory (ROM), a random-access memory (RAM), a solid state drive (SSD), an optical disc, or the like. The RAM may include a resistance random access memory (ReRAM) and a dynamic random access memory (DRAM).

In an example, a computer program product is further provided. The computer program product includes a computer program, the computer program being stored in a computer-readable storage medium. A processor of a computer device reads the computer program from the computer-readable storage medium and executes the computer program, to cause the computer device to perform the foregoing information display method.

What is claimed is:

1. An information display method, the method comprising:
displaying, by processing circuitry, a first virtual object of a plurality of virtual objects in a first level of a chess game, the first virtual object being associated with a first user account;
displaying, when a number of the plurality of virtual objects of the first level reaches a preset number, a first voucher and a second virtual object of a second level, the second virtual object being synthesized based on the preset number of the plurality of virtual objects;
displaying at least two candidate virtual objects when the first voucher is redeemed; and
displaying, when one of the at least two candidate virtual objects is selected by the first user, the selected candidate virtual object as obtained by the first user account.

2. The method according to claim 1, wherein the displaying the at least two candidate virtual objects further comprises:
displaying a redemption interface corresponding to the first voucher, the redemption interface including at least one of:
an option for a virtual resource, or
a delay selection control,
wherein a virtual item used in the chess game is redeemable with the virtual resource, and the delay selection control is configured to retract the redemption interface.

3. The method according to claim 1, wherein the method further comprises:
displaying a user interface including a preparation area and a battle area, the preparation area being configured to display virtual objects waiting to participate in a battle, and the battle area being configured to display virtual objects participating in the battle; and
wherein the displaying the first voucher further comprises:
displaying, when a display position is available in the preparation area, the first voucher at the display position in the preparation area; and
displaying the first voucher in the battle area when the display position is not available in the preparation area and the first user account is in a preparation state.

4. The method according to claim 3, wherein
when the display position is not available in the preparation area and the first user account is in a battle state, the first voucher is automatically redeemed.

5. The method according to claim 3, wherein the displaying the first voucher in the battle area further comprises:
moving the first voucher from the battle area to the available display position in the preparation area for display when the display position is available in the preparation area.

6. The method according to claim 3, wherein the displaying the selected candidate virtual object as obtained by the first user account further comprises:
displaying the selected candidate virtual object at the available display position in the preparation area when the display position is available in the preparation area; and
displaying the selected candidate virtual object in a temporary preparation area of the user interface when the display position is not available in the preparation area and the first user account is in a preparation state, the temporary preparation area being configured to display virtual objects that cannot be displayed in the preparation area.

7. The method according to claim 6, wherein the method further comprises:
displaying battle prompt information when the display position is not available in the preparation area and the first user account is in a battle state, the battle prompt information being configured to indicate the first user account is currently in the battle state and the candidate virtual object is to be selected after the battle state ends.

8. The method according to claim 1, wherein
a grade represents a battle ability of the virtual object in the chess game;
a rare level represents a rareness of the virtual object;
a function type represents a function of the virtual object in the chess game; and
the at least two candidate virtual objects being associated with at least one of the grade, the rare level, or the function type of the first virtual object.

9. The method according to claim 1, wherein the first virtual object of the first level is obtained by at least one of:
redeeming the first voucher for the first virtual object of the first level;
obtaining the first virtual object of the first level by using a skill;
redeeming a second voucher for the first virtual object of the first level based on lottery; and
redeeming the first voucher for the first virtual object of the first level based on lottery.

10. The method according to claim 1, wherein the method further comprises:
displaying upgrade prompt information when the number of the plurality of virtual objects of the first level reaches the preset number, the upgrade prompt information being configured to prompt for upgrade of the first virtual object;
displaying the first voucher and the synthesized second virtual objects of the second level when an upgrade operation is selected on the upgrade prompt information.

11. A display apparatus, comprising:
processing circuitry configured to:
display a first virtual object of a plurality of virtual objects in a first level of a chess game, the first virtual object is associated with a first user account;
display, when a number of the plurality of virtual objects of the first level reaches a preset number, a first voucher and a second virtual object of a second level, the second virtual object is synthesized based on the preset number of the plurality of virtual objects;
display at least two candidate virtual objects when the first voucher is redeemed; and
display, when one of the at least two candidate virtual objects is selected by the first user, the selected candidate virtual object as obtained by the first user account.

12. The apparatus according to claim 11, wherein the processing circuitry is configured to:
display a redemption interface corresponding to the first voucher, the redemption interface includes at least one of:
an option for a virtual resource, or
a delay selection control,
wherein a virtual item used in the chess game is redeemable with the virtual resource, and the delay selection control is configured to retract the redemption interface.

13. The apparatus according to claim 11, wherein the processing circuitry is configured to:
display a user interface includes a preparation area and a battle area, the preparation area is configured to display virtual objects waiting to participate in a battle, and the battle area is configured to display virtual objects participating in the battle;
display, when a display position is available in the preparation area, the first voucher at the display position in the preparation area; and
display the first voucher in the battle area when the display position is not available in the preparation area and the first user account is in a preparation state.

14. The apparatus according to claim 13, wherein
when the display position is not available in the preparation area and the first user account is in a battle state, the first voucher is automatically redeemed.

15. The apparatus according to claim 13, wherein the processing circuitry is configured to:
move the first voucher from the battle area to the available display position in the preparation area for display when the display position is available in the preparation area.

16. A non-transitory computer-readable storage medium, storing instructions which when executed by a processor cause the processor to perform:
displaying a first virtual object of a plurality of virtual objects in a first level of a chess game, the first virtual object being associated with a first user account;
displaying, when a number of the plurality of virtual objects of the first level reaches a preset number, a first voucher and a second virtual object of a second level, the second virtual object being synthesized based on the preset number of the plurality of virtual objects;
displaying at least two candidate virtual objects when the first voucher is redeemed; and
displaying, when one of the at least two candidate virtual objects is selected by the first user, the selected candidate virtual object as obtained by the first user account.

17. The non-transitory computer-readable storage medium according to claim 16, wherein the displaying the at least two candidate virtual objects further comprises:
displaying a redemption interface corresponding to the first voucher, the redemption interface including at least one of an option for a virtual resource or a delay selection control,
wherein a virtual item used in the chess game is redeemable with the virtual resource, and the delay selection control is configured to retract the redemption interface.

18. The non-transitory computer-readable storage medium according to claim 16, wherein the instructions when executed by the processor further cause the processor to perform:
displaying a user interface including a preparation area and a battle area, the preparation area being configured to display virtual objects waiting to participate in a battle, and the battle area being configured to display virtual objects participating in the battle; and
wherein the displaying the first voucher further comprises:
displaying, when a display position is available in the preparation area, the first voucher at the display position in the preparation area; and
displaying the first voucher in the battle area when the display position is not available in the preparation area and the first user account is in a preparation state.

19. The non-transitory computer-readable storage medium according to claim 18, wherein when the display position is not available in the preparation area and the first user account is in a battle state, the first voucher is automatically redeemed.

20. The non-transitory computer-readable storage medium according to claim 18, wherein the instructions when executed by the processor further cause the processor to perform:
moving the first voucher from the battle area to the available display position in the preparation area for display when the display position is available in the preparation area.
